(19) United States
(12) Patent Application Publication
(10) Pub. No.: US 2010/0086759 A1
(43) Pub. Date: Apr. 8, 2010

(54) Fitness and therapy mat for standing and walking

(75) Inventor: Karl Muller, Roggwil (CH)

Correspondence Address: Euromaier LLC, 707 Skokie Blvd, Ste 600, Northbrook, IL, 60062, US

(73) Assignee: KYBUN AG, Roggwil (CH)

(21) Appl. No.: 12/489,762

(22) Filed: Jun. 23, 2009

(30) Foreign Application Priority Data
Jan. 19, 2007 (CH) 00082/07

(51) Int. Cl. A63B 6/00; B32B 27/40; B32B 3/26

(52) U.S. Cl. 428/220; 428/304.4

(57) ABSTRACT

The invention proposes a fitness and therapy mat for standing and walking made of foamed material for sport, gymnastic, and therapeutic purposes. The foamed material used has an open cell structure. Thus the elasticity of the foamed material structure alone determines the spring action of the mat when the mat is under stress. The spring action of the fitness and therapy mat approaches the ideal spring, and the resilience shows minimal damping.

The present invention relates to a fitness and therapy mat for standing and walking in accordance with the preamble of claim 1.

The use of fitness and gymnastics mats has become established in the sports sector. In kindergartens and after-school care clubs they are used for playing games, while in school sports, and also in gymnastics clubs and sports clubs, they have become indispensible for all floor exercises. This type of mat is designed for avoiding contact with cold and hard floor surfaces. The leading manufacturers include Airex, Bremshey, Merida and Movivit. Thieme-Sport is an important player in Germany. These mats do not have any covers. For this reason, their surfaces have to be designed such that they are robust, easy to clean, hygienic and skin-compatible. Other important features are the non-slip nature of the undersides and the low overall weight of the mat. Many different types of foamed material mats are also used in physiotherapy.

The foundations for the construction of such mats were laid in the 1970s. Typical mats are still provided today with a soft core and a durable casing. It was recognized early on that the protective casing has to be firmly connected to the foam core. A typical design is shown in patent no. DE 2124627 from the year 1971. Even today, fitness and therapy mats are produced mainly according to this principle. DE 2510863 from the year 1975 discloses a gymnastics mat or foot mat made of polyurethane. At that date, the advantages of the new material “polyurethane” were recognized and were being exploited in the production of such mats. These mats were used primarily as “shock-absorbing mats”, as are also proposed in patent no. EP 0 433 237 B1. A mat whose purpose is to absorb an impact should have “delayed shape recovery” in order to ensure that the sportsperson landing on it is not immediately catapulted off again by the spring action.

Nowadays, when it is generally recognized that, according to www.rheumaliga.ch, “regular and specific gymnastics with a therapy and training device bring soul, body and spirit into harmony”, products are sold that permit “gymnastics on site”. Such fitness and therapy mats generally have a rectangular shape, almost that of a square, and have a surface area of ca. 0.06 m³ to 1 m³. Their thickness is mostly 1.5 cm to 10 cm. Such mats are often used by several different people, such that they have to meet quite high demands regarding hygiene. Mats are therefore used that have “optimal damping and a closed-cell structure and do not take up moisture or dirt” (translated from the original German in http://www.airex.ch/de/catalog.php?tipo=30&catab=1). Importance is therefore placed on multifunctionality and on resistance to moisture and rotting. They are used for gymnastics and exercises performed when standing, sitting, kneeling and moving. It has been found that gymnastics performed with foamed cushions of this kind promote the muscles of the feet and encourage a firm stance, the basis of an upright posture.

All of these foamed material mats have closed pores, in other words they have a closed-cell structure. The spring-back effect is achieved by the combined action of the air compressibility in the pores and the elasticity of the material. In accordance with the principle of a pneumatic spring, a mat of this kind becomes progressively harder the more it is loaded.

As is described in the prior art, the conventional mats are provided with a protective casing. This protective casing means that a larger area around the point of impression is also influenced. The effect corresponds to that of an air-filled cushion. The laterally acting forces are led off via the protective casing, which results in what is called “wobble effect”. However, the desired effect is partially negated by the choice of the above-described foamed materials and by the design with a plastic protective casing and a foamed material core that are firmly connected to each other. Nevertheless, the mats according to the prior art are popular because of their versatility, e.g. they can also be used in water. However, they cannot satisfy the requirements of the physiotherapeutically desirable instability effect.

The damping effect described in EP 0 433 237 B1 is typical of all the mats of this kind according to the prior art. For the purposes of hygiene and multi-functionality, closed-cell foamed materials are used for these mats, as has already been mentioned, and they are then additionally provided with a closed casing made of the same material or of another material. This has a negative effect on the instability that is important for activation of all the muscles of the locomotor system and on the desired spring action.

The object of the present invention is now to improve the fitness and therapy mat by using a plastic foam that is produced from an open-cell material and that is specially configured for this use, and to do so in such a way that, for the person undergoing the therapy, a spring-back effect coming close to the ideal spring permits maximum instability of the device.

This object is achieved by a fitness and therapy mat having the features of claim 1. Other features according to the invention are set forth in the dependent claims, and the advantages of these features are explained in the description below.

In the drawing:

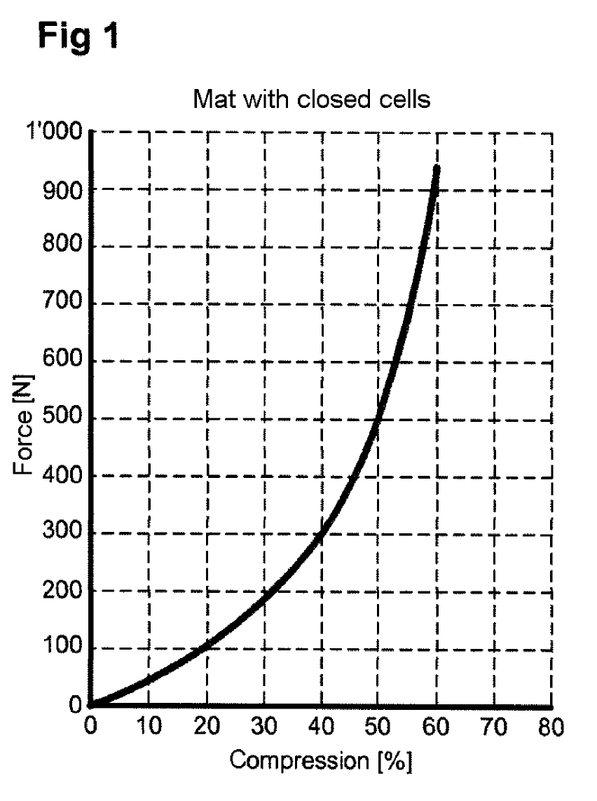

FIG. 1 shows the compression curve of a mat with closed cells,

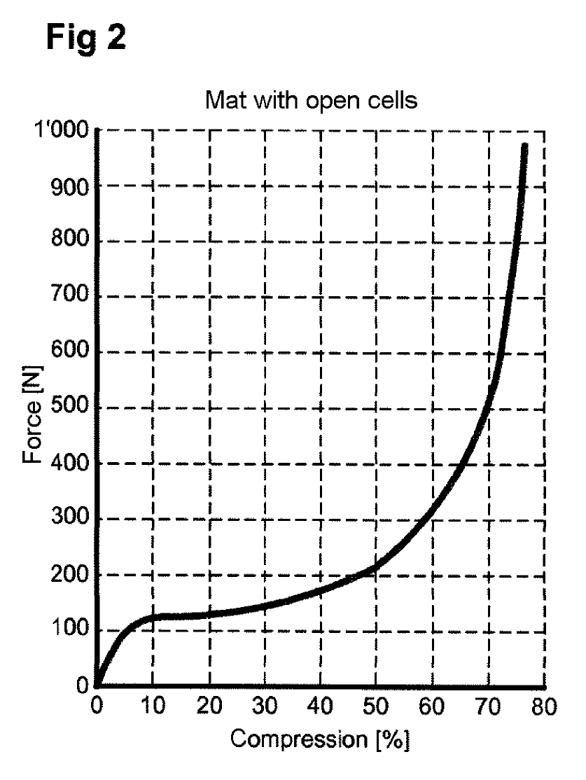

FIG. 2 shows the compression curve of a mat with open cells,

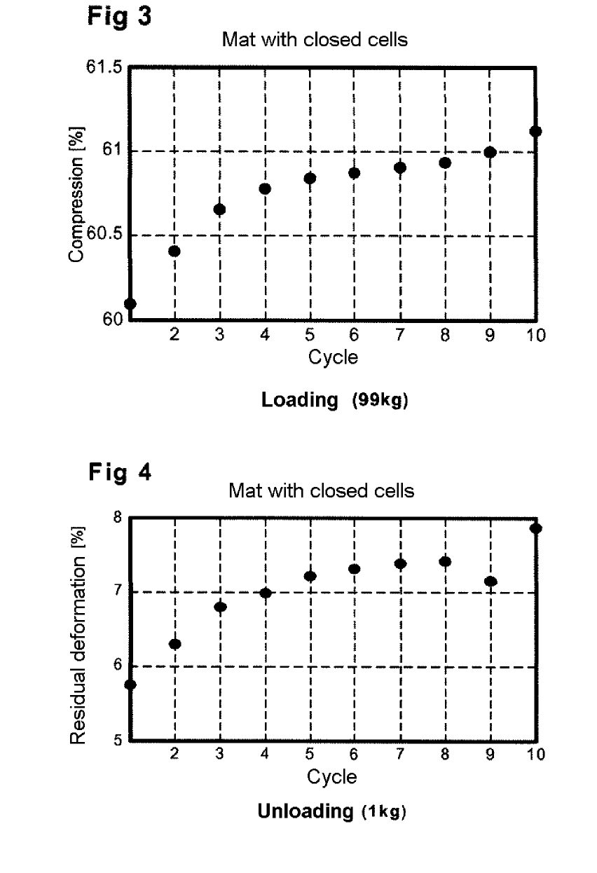

FIG. 3 shows the compression, during 10 cycles, of a mat with closed cells,

FIG. 4 shows, in percentages, the residual deformation of a mat with closed cells during 10 cycles,

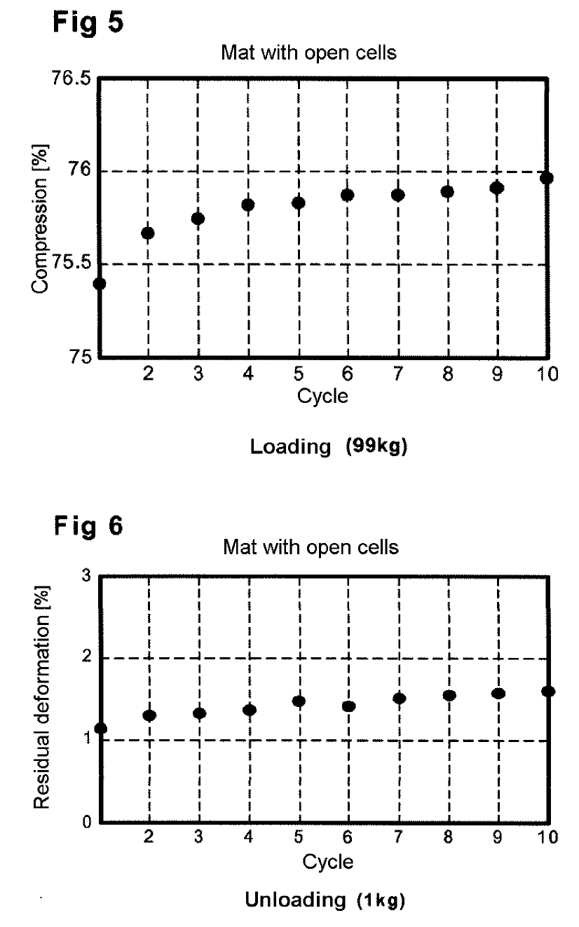

FIG. 5 shows the compression, during 10 cycles, of a mat with open cells,

FIG. 6 shows, in percentages, the residual deformation of a mat with open cells during 10 cycles.

The figures show the measurement results of comparison measurements between open-cell and closed-cell mats. These can be inspected in test report no. 444'254 of Nov. 27, 2006, of the Swiss Federal Laboratories for Materials Testing and Research.

The spring-back effect of the fitness and therapy mat specified in claim 1 will be less progressive and, upon light loading, almost proportional. The omission of a casing that is firmly connected to the soft resilient core reduces the transmission of horizontal forces, which are transmitted in conventional and commercially available mats with tough, tear-resistant protective casings. The open-cell structure of the foam, which is achieved by the use of the special material, minimizes the transmission of horizontal forces in a detectable way. The open-cell structure is also maintained to the outside on the tread surface and lateral surface, by means of the mats being cut cleanly, such that the open-cell structure permits exchange of air from the inside to the outside. The spring action is intended to be achieved by the cell structure alone. Inclusions of air, which would bring about the effect of air compression, are avoided. Only on the face directed toward the floor is a film adhesively affixed in order to make the mat non-slip.

In order to obtain this open-cell structure, the proposed fitness and therapy mat is made from a flexible polyurethane foam which is produced mainly from polyols and diisocyanates.

The proposed fitness and therapy mat for standing and walking is intended to motivate sedentary individuals to stand and to encourage them to move. The standing-up concept can have a positive influence on the state of health of the person doing the training, and without great expenditure, since it acts in a targeted manner on the deep-lying muscle layers. By simply standing and moving on this mat, which is provided in different lengths and thicknesses, the interaction between brain, nerves and muscles of the motor system is activated, exercised and improved in a simple way.

By virtue of its unique open-cell structure, this mat is an ideal training device, since the unstable base imposes a healthy movement and posture of the feet. The muscles of the feet are at all times actively required to maintain the body's balance. Sensory information from the sole of the foot is conveyed via the nervous system to the brain. From there, impulses that promote activity are also forwarded to all the muscles of the trunk. In this way, the deeper-lying muscle areas of the feet, legs and back are exercised and strengthened almost unconsciously. Pain quickly subsides, and a sense of well-being grows. “Proprioception” (awareness of one's own body, cf. “Digression”) is the key to success here.

If the body, as an “adaptable being”, lacks motor stimuli, the muscles become hypotrophic. Minor everyday loads that exceed the actual loading capacity of a hypotrophic muscle lead to typical reactions, such as increased muscle tone. Lack of motor stimuli can finally lead to restructuring of the supportive tissue (cartilage, bone) and to muscle imbalances.

These general movement advantages result therefrom:
positive influence on fat and carbohydrate
metabolism
weight reduction
lower blood pressure
improved flow of the blood
improved elasticity of the blood vessels
breakdown of free radicals
overall strength increased in the long term by training of intermuscular and intramuscular coordination
the everyday load placed on the locomotor system is reduced as a result of the increase in overall strength
combined everyday movements are exercised and prevent injuries from falls

The proposed fitness and therapy mat for standing and walking has the following effects:
compensation of unilateral loading
strengthening of the muscles and reduction of tonicity
improved physical performance through direct reduction of stress
improved cognitive performance through moderate movement on the mat (cf. study by Prof. Dr. Henner Ertel; www.grp-net.com)
increased powers of concentration through improved blood flow and oxygen supply
harmonization of breathing and of other vegetative body functions
strengthening of the cardiovascular system
prevention of high blood pressure
positive influence on the immune system
improved everyday motoricity (coordination)
reduced risk of falls in elderly subjects
reduced incidence of limping in elderly subjects
fewer vein-related problems

The proposed mat offers the user the following:
simple, easy-to-follow exercises
sense of balance can be improved by exercises (closed eyes, balancing)
exercises can be combined with equipment (dumb-bells, bar, juggling with balls)
exercises can be performed with or without music, at the workplace, at home, when ironing, while talking on the phone, wherever one is at a fixed location
standing and moving on the mat according to the invention requires one to listen to the body's signals, to know one's body better and to care for it
the mat satisfies the high demands of its customers from the following areas (offices, industry, prevention, rehabilitation, medicine, sports clubs and home users):
   minimal time expenditure and effort
   at the same time a high training effect

The proposed mat is available in different thicknesses, specifically from 1.5 to 10 cm thick. The rule is that the thicker the mat, the more unstable are the movements on it. The length can be up to 5 m. To meet the strict hygiene requirements without compromising the desired properties of the fitness and therapy mat, a washable cover is used.

The following recommendations are made regarding the use of the proposed fitness and therapy mat:

Standing and moving on the mat should be done with bare feet or wearing socks. A shoe would take away the feel of the load of the foot on the mat. The sole of the foot, by contrast, is “massaged” on the proposed fitness and therapy mat. In this way, the foot is even able to correct the foot position by direct contact with the mat. Warm feet with good circulation of blood allow a feeling of wellbeing to radiate into the whole body.

This fitness and therapy mat is also suitable for use after injuries, or as rehabilitation training aid after operations. In this connection a brief digression:

The fitness and therapy mat has a principle of action similar to that of “proprioceptive neuromuscular facilitation (PNF)”, which has become established as a tried and tested approach in physiotherapy. PNF is a treatment method based on neurophysiology. It was developed from 1946 to 1951 at the Kaiser Foundation Center in Vallejo, Calif., by the neurophysiologist Dr. Herman Kabat and the physiotherapist Margaret Knott, based on neurophysiological principles which were described by, among others, the British neurophysiologist Sir Charles Scott Sherrington (1857-1952). The underlying principle of PNF treatment is the observation that “every human being has latent (dormant) motor abilities that can be activated by suitable facilitation*” (Kabat 1950). *facilitate=to normalize muscle tension, e.g. to activate weak or paralyzed muscles. The method seeks—like kybun—to normalize disrupted movement patterns.

For this purpose, the pressure and stretch receptors in muscles (proprioceptors), but also the tendons and connective tissues, are stimulated, for example by pressure, extension, relaxation or stretching, and information is conveyed via the nerve paths to the spinal cord and brain. These actions are performed in certain predetermined sequences.

The movement patterns can be seen in static functions and dynamic functions of our body. They are in most cases less evident to the untrained eye, although they are always present in normal motoricity. They are three-dimensional and diagonal, since the musculature is helical. Therapeutic work is thus performed with defined movement patterns and specific techniques. This leads to increased reaction in the muscles, e.g. to increased muscle contraction or relaxation. An important aspect of PNF is the summation of stimuli, whether exteroceptive (tactile, visual, acoustic) or proprioceptive (through muscle, joint and tendon receptors), in order to achieve a result that is as comprehensive as possible. Kybun confines itself to proprioceptive stimuli.

The objectives of PNF are:
to normalize muscle tension (e.g. to reduce spasticity or to activate weak or paralyzed muscles)=facilitate
to promote motor control
to promote mobility
to promote dynamic stability, stamina, strength
to promote agility, coordination

End of Digression

In this connection, the applicant shares the view of Dr. med. Alois Brügger (www.bruegger.com), that most diseases of the locomotor system are primarily attributable not to structural diseases but to protective mechanisms of the brain that are organized in the central nervous system. These protective mechanisms are triggered by incorrect loading and excessive loading. In cases of chronic incorrect loading, functional disturbances first appear, which can later develop into structural changes.

This can be avoided if the system of movement (postural and locomotor system) is used optimally, by means of physiologically dynamic posture in combination with corrected movement patterns. It is precisely this that the kybun fitness and therapy mat for standing and walking can offer:

The method for which the proposed fitness and therapy mat for standing and walking is intended:
Recognition and elimination of the existing disturbance factors, and correction of incorrect posture and improvement of movement patterns
Optimal use of all structures according to their function by means of an upright posture; reduction of bending stress to a minimum
Automation by repetition of standing and moving on the mat
Fostering of a positive attitude and active involvement through a variety of possible uses

A change of posture also results in a change of behavior. In the upright posture, the muscles are in an optimal working position. All structures obtain an optimal development stimulus (bone compression/tension ratio).

Thus, the mat is eminently suitable as a supportive and supplementary therapy measure, especially in persons who are overweight, whose movement is restricted or who have problems in the areas of the back, hips, joints and veins. People not only rediscover the pleasure of movement on the soft special mat; with special moderate exercises, the muscles, tendons and ligaments are also loosened, the joints are looked after, the metabolism is stimulated, and the cardiovascular system improved. By means of the movements on an unstable base, the deep, stabilizing muscles are intensively exercised, which significantly improves body coordination. The gentle movements release all muscle tension, promote lymph flow, stimulate digestion and prevent osteoporosis. Pains in the neck, shoulders, back, hips, thighs, knees, calves or the joints of the feet in most cases cease or can at least be alleviated. With the blood circulation boosted, toxins can be better transported out of the body and inflammation subsides more rapidly. Functional performance improves and stress symptoms disappear.

To verify the physical difference, the EMPA (Swiss Federal Laboratories for Materials Testing and Research) in St. Gallen commissioned static and dynamic tests on two foamed material mats. The results of these tests were set out in EMPA test report no. 444'254 of Nov. 27, 2006. A mat measuring 500×410×70 cm with closed cells and a mat of the type according to the invention with open cells and with dimensions of 460×460×60 were compared.

Dynamic Measurements

For dynamic measurement, a drop body was allowed to fall from a defined height onto the test specimen. The deceleration of the drop body was detected using an acceleration sensor. The speed, depth of penetration and resulting force of the drop body were calculated from the acceleration values. The drop height was set in such a way that the maximum force of a static load corresponded to a mass of around 30 and 100 kg. These drop tests were carried out in accordance with EN 1177 (impact-absorbing playground surfacing).

Test equipment:

Drop hook 20 kN (SOP 02'736)

Drop body according to EN 1177, semisphere, r=80 mm, 4.6 kg (SOP 03'322)

Acceleration sensor with charge amplifier (SOP 02'087)

Data acquisition system (SOP 01'550 and 01'612)

Concrete base with embedded steel plate (Cl. 12)

The outcome of the dynamic measurements can be summarized in one sentence: Upon penetration of the semispherical drop body, the loading of the mat with open cells, the mat according to the invention, is fairly linear, i.e. the depth of penetration in percent is almost proportional to the respectively chosen weight of the drop body. In the mat with closed cells, a clear progression can be seen in the same test setup. It appears that the gas trapped in the closed cells determines the compression properties.

Static Measurements

For static measurement, the test specimens were placed between two parallel plates and loaded at constant speed to a maximum value and then unloaded. This cycle was repeated a total of 10 times. The loading force and the position of the plates were recorded during the test procedure. Specimens with a surface area measuring 100×100 mm were cut out for use in these tests.

Test equipment: Zwick universal testing machine for compression and tension testing (SOP 02'022)

Test speed 100 mm/min

Cycle number 10

Maximum load 100 kg, i.e. 981 N

The measurement results for the test specimens tested on the Zwick universal tension testing machine are shown in FIGS. 1 and 2. FIG. 1 shows the results of a mat with closed cells, while FIG. 2 shows the results of a mat with open cells.

The loading profiles are distinctly different. In the test specimen with closed cells (FIG. 1), the force increases constantly from the start. When the load is removed, it is found that the material cannot fully recover its shape at the test speed (100 mm/min), although the hysteresis is fairly low. This diagram corresponds for the most part to a curve for compressed air.

By contrast, the force profile of the test specimen with open cells (FIG. 2) can be clearly divided into three areas. The first elastic increase to ca. 5% deformation, the plateau to ca. 50% deformation, and then the compression phase with the steep upward slope.

At a load of 99 kg, a compression in the range from 60% to 61% can be seen in the closed cells (FIG. 3). By contrast, the mat with open cells is resilient in a range from 75% to 76% (FIG. 5). The result after the load is decreased to 1 kg is shown in FIGS. 4 and 6. The residual deformation of the mat with open cells (FIG. 6) at 1% to 2% is significantly lower than the residual deformation of the mat with closed cells (FIG. 4), which is between 6% and 8%. In addition, in the mat with closed cells (FIG. 3 and FIG. 4), the settlement process, which determines the deformation, is still incomplete after 10 cycles, whereas in the mat with open cells (FIG. 6) it remains almost constant at a low level after just a few cycles.

This property of open-cell mats, clearly demonstrated in the test, takes effect within the meaning of the invention in the fitness and therapy mat for standing and walking.

1. A fitness and therapy mat for standing and walking made of foamed material for sport, gymnastic and therapeutic purposes, wherein said foamed material has an open-cell structure, with closed pores being avoided, such that, when loaded, the elasticity of said foamed material structure alone determines the spring action of said mat, said spring action approaches the ideal spring and has minimal damping in the back-spring, and the thickness of said mat is between 1.5 cm and 10 cm.

2. A fitness and therapy mat for standing and walking, wherein lateral surfaces, as well as the tread and support surface of said mat, have an open-cell structure.

3. The fitness and therapy mat for standing and walking as claimed in claim 1, wherein said foamed material is a flexible polyurethane foam produced from polyols and diisocyanates.

4. The fitness and therapy mat for standing and walking as claimed in claim 1, wherein said foamed material becomes more elastic the more it is compressed.

5. The fitness and therapy mat for standing and walking as claimed in claim 1, wherein said foamed material in its force/path ratio between 10 and 50 percent deformation has a linear and proportional increase of the compression for the deformation.

6. The fitness and therapy mat for standing and walking as claimed in claim 1, wherein the cell structure of said foamed material can be compressed by up to 76% and returns almost completely to shape immediately after the compression.

7. The fitness and therapy mat for standing and walking as claimed in claim 1, wherein a washable and removable cover for said mat is made of polyester/elastane and is sufficient for hygiene, and said mat properties remain unaffected by said cover.

8. A fitness and therapy mat for standing and walking, wherein on the face of said mat directed toward the floor, the open-cell structure is affixed with a non-slip protective film.
